(19) United States
(12) Patent Application Publication
(10) Pub. No.: US 2022/0336139 A1
(43) Pub. Date: Oct. 20, 2022

(54) COUPLED INDUCTOR AND THE METHOD TO MAKE THE SAME

(71) Applicant: CYNTEC CO., LTD., Hsinchu (TW)

(72) Inventors: Li-Jung Yang, HSINCHU (TW); Xiang Jun Li, Jiangsu (CN); Chenlun Huang, HSINCHU (TW)

(21) Appl. No.: 17/720,281

(22) Filed: Apr. 13, 2022

Related U.S. Application Data
(60) Provisional application No. 63/174,551, filed on Apr. 14, 2021.

(51) Int. Cl. H01F 27/28; H01F 27/32; H01F 27/24; H01F 27/02; H01F 41/04; H01F 41/12

(52) U.S. Cl. CPC H01F 27/2804; H01F 27/323; H01F 27/24; H01F 27/022; H01F 41/042; H01F 41/122; H01F 2027/2809

(57) ABSTRACT

A coupled inductor has two coils made by film processes, wherein a first coil is disposed on a top surface of a magnetic sheet and a second coil is disposed on a bottom surface of the magnetic sheet, for controlling the variations of the gap between the two coils in a smaller range.

### CROSS-REFERENCES TO RELATED APPLICATIONS

This application claims the benefit of U.S. Provisional Patent Application No. 63/174,551 filed on Apr. 14, 2021, which is hereby incorporated by reference herein and made a part of the specification.

### BACKGROUND OF THE INVENTION

### I. Field of the Invention

The present invention relates to a coupled inductor, and in particular, to a coupled inductor made by a film process.

### II. Description of Related Art

A conventional coupled inductor uses two coils made of discrete conductive wires, wherein each coil is wound on a corresponding pillar in a vertical direction. However, the variations of the gap between the two coils can vary in a larger range for the coupled inductors, which will affect the reliability and performance of the coupled inductors.

Furthermore, the conventional coupled inductor uses the first mold, as shown in FIG. 1A, and the second mold, as shown in FIG. 1B, wherein a first coil C1 is wound around a pillar P1 and a second coil C2 is wound around a pillar P2, so the deviation of the center of the column can be the sum of the first mold deviation and the second mold deviation plus the combined process deviation. In addition, each conventional coupled inductor is made separately, so the deviation of the center of the column is a Gaussian Distribution, which is a big variation range and not good for maintaining the reliability and performance of the products.

Furthermore, as shown in FIG. 1C and FIG. 1D, the gap between the upper coil C2 and the lower coil C1 can vary in a big range such as 0-76 um, which is also not good for maintaining the reliability and performance of the products.

Therefore, a better solution is needed to resolve the above-mentioned issues.

### SUMMARY OF THE INVENTION

The present invention provides a coupled inductor having two coils made of film processes for controlling the variations of the gap between the two coils in a smaller range.

The present invention provides a method to make a plurality of coupled inductors in a single process, wherein the plurality of coupled inductors made of film processes can control the variations of the gap between the two coils in a smaller range for maintaining the reliability and performance of the products made in batch production, wherein the standard deviation of K (coupling coefficient) value is decreased significantly for all of the finished products in batch production.

In one embodiment, a coupled inductor is disclosed, wherein the coupled inductor comprises: a first coil-structure, comprising at least one first conductive layer, wherein each conductive layer is formed on a corresponding insulating layer, wherein the at least one first conductive layer comprises first conductive patterns for forming at least one first winding turn of a first coil; a second coil-structure, comprising at least one second conductive layer, wherein each conductive layer is formed on a corresponding insulating layer, wherein the at least one second conductive layer comprises second conductive patterns for forming at least one second winding turn of a second coil; a magnetic sheet, wherein the first coil-structure is disposed over a top surface of the magnetic sheet, and the second coil-structure is disposed over a bottom surface of the magnetic sheet, wherein the first coil-structure and the second coil-structure are on two opposite sides of the magnetic sheet, wherein a vertical line passes through a first hollow space of the at least one first winding turn of the first coil and a second hollow space of the at least one second winding turn of the second coil.

In one embodiment, the coupled inductor comprises a first magnetic body and a second magnetic body, wherein the first magnetic body is disposed on the top surface of the magnetic sheet to encapsulate the at least one first winding turn of the first coil, and wherein the second magnetic body is disposed on the bottom surface of the magnetic sheet to encapsulate the at least one second winding turn of the second coil.

In one embodiment, the at least one first conductive layer comprises a first plurality of conductive layers, wherein each conductive layer of the first plurality of conductive layers is formed sequentially on a corresponding insulating layer starting from a first bottom insulating layer, wherein the first bottom insulating layer is in contact with the top surface of the magnetic sheet.

In one embodiment, the at least one first conductive layer comprises a first plurality of conductive layers, wherein each conductive layer of the first plurality of conductive layers is formed sequentially on a corresponding insulating layer starting from a first bottom insulating layer, wherein the first plurality of conductive layers are located between the first bottom insulating layer and a first top insulating layer, wherein the first bottom insulating layer is in contact with the top surface of the magnetic sheet.

In one embodiment, the at least one second conductive layer comprises a second plurality of conductive layers, wherein each conductive layer of the second plurality of conductive layers is formed sequentially on a corresponding insulating layer starting from a second bottom insulating layer, wherein the second bottom insulating layer is in contact with the bottom surface of the magnetic sheet.

In one embodiment, the at least one second conductive layer comprises a second plurality of conductive layers, wherein each conductive layer of the second plurality of conductive layers is formed sequentially on a corresponding insulating layer starting from a second bottom insulating layer, wherein the second plurality of conductive layers are located between the second bottom insulating layer and a second top insulating layer, wherein the second bottom insulating layer is in contact with the bottom surface of the magnetic sheet.

In one embodiment, the first magnetic body comprises a first unitary magnetic body that encapsulates the at least one first winding turn of the first coil and extends into the first hollow space of the first coil.

In one embodiment, the second magnetic body comprises a second unitary magnetic body that encapsulates the at least one second winding turn of the second coil and extends into the second hollow space of the first coil.

In one embodiment, the first winding turn is formed on the first bottom insulating layer, wherein a corresponding insulating layer is formed on a first conductive layer comprising the first winding turn, wherein said corresponding insulating layer encapsulates the first winding turn and extends into an unpatterned area of the first conductive layer.

In one embodiment, the second winding turn is formed on the second bottom insulating layer, wherein a corresponding insulating layer is formed on a second conductive layer comprising the second winding turn, wherein said corresponding insulating layer encapsulates the second winding turn and extends into an unpatterned area of the second conductive layer.

In one embodiment, each of the at least one first conductive layer is formed by a film process.

In one embodiment, each of the at least one first conductive layer is formed by a thin film process.

In one embodiment, each of the at least one first conductive layer is formed by a thick film process.

one embodiment, each of the at least one second conductive layer is formed by a film process.

In one embodiment, each of the at least one second conductive layer is formed by a thin film process.

In one embodiment, each of the at least one second conductive layer is formed by a thick film process.

In one embodiment, the first magnetic body is formed by a first material, and the magnetic sheet is formed by a second material that is different from the first material.

In one embodiment, each of the first magnetic body and the magnetic sheet is formed by a first material.

In one embodiment, each of the first magnetic body and the second magnetic body is formed by a first material, and the magnetic sheet is formed by a second material that is different from the first material.

In one embodiment, the first magnetic body is formed by a first material, the magnetic sheet is formed by a second material that, and the second magnetic body is formed by a third material, wherein the first material, the second material, and the third material are different from each other.

In one embodiment, each of the first coil-structure and the second coil-structure is formed by a corresponding lithography process, wherein the at least one first winding turn of the first coil and the at least one second winding turn of the second coil are formed by a same set of image patterns being used in said corresponding lithography process.

In one embodiment, a method to form a coupled inductor is disclosed, wherein the method comprises: forming a first coil-structure, wherein the first coil-structure comprises at least one first conductive layer with each conductive layer thereof being formed on a corresponding insulating layer, wherein the at least one first conductive layer comprises first conductive patterns for forming at least one first winding turn of a first coil; forming a second coil-structure, wherein the second coil-structure comprises at least one second conductive layer with each conductive layer thereof being formed on a corresponding insulating layer, wherein the at least one second conductive layer comprises second conductive patterns for forming at least one second winding turn of a second coil; disposing the first coil-structure on a top surface of the magnetic sheet, and disposing the second coil-structure on a bottom surface of the magnetic sheet, wherein a vertical line passes through a first hollow space of the at least one first winding turn of the first coil and a second hollow space of the at least one second winding turn of the second coil.

In one embodiment, each of the at least one first conductive layer is formed by a film process.

In one embodiment, each of the at least one first conductive layer is formed by a thin film process.

In one embodiment, each of the at least one first conductive layer is formed by a thick film process.

one embodiment, each of the at least one second conductive layer is formed by a film process.

In one embodiment, each of the at least one second conductive layer is formed by a thin film process.

In one embodiment, each of the at least one second conductive layer is formed by a thick film process.

In one embodiment, the method comprises disposing a first magnetic body on the top surface of the magnetic sheet to encapsulate the at least one first winding turn of the first coil and extends into the first hollow space of the first coil.

In one embodiment, the method comprises disposing a second magnetic body on the bottom surface of the magnetic sheet to encapsulate the at least one second winding turn of the second coil and extend into the first second space of the second coil.

In one embodiment, a method for forming a plurality of coupled inductors is disclosed, wherein the method comprises: forming a first insulating layer on a first carrier, and forming at least one first conductive layer over the first insulating layer, wherein the at least one first conductive layer comprises first conductive patterns for forming a plurality of first coils; removing the first carrier to obtain a first sheet comprising the first insulating layer and the plurality of first coils; forming a second insulating layer on a second carrier and forming at least one second conductive layer over the second insulating layer, wherein the at least one second conductive layer comprises second conductive patterns for forming a plurality of second coils; removing the second carrier to obtain a second comprising the second insulating layer and the plurality of second coils; disposing the first sheet on a top surface of a third sheet comprising a magnetic material; disposing the second sheet on a bottom surface of the third sheet.

In one embodiment, the method comprises disposing a fourth sheet comprising a magnetic material on the top surface of the first sheet.

In one embodiment, the method comprises disposing a fifth sheet comprising a magnetic material on the bottom surface of the second sheet.

In one embodiment, the first insulating layer is in contact with the top surface of the third sheet, and the second insulating layer is in contact with the bottom surface of the third sheet.

In one embodiment, the first coil is formed by a first plurality of conductive layers, wherein the first winding turn is formed on a first insulating layer disposed on the carrier, wherein a third insulating layer is formed on the first winding turn, wherein the first insulating layer is in contact with the top surface of the magnetic sheet.

In one embodiment, the second coil is formed by a second plurality of conductive layers, wherein the second winding turn is formed on a second insulating layer disposed on the carrier, wherein a fourth insulating layer is formed on the first winding turn, wherein the second insulating layer is in contact with the bottom surface of the magnetic sheet.

In one embodiment, a method for forming method for forming a plurality of coupled inductors is disclosed, wherein the method comprises: forming a first sheet, wherein the first sheet comprises a first insulating layer and at least one first conductive layer over the first insulating layer, wherein the at least one first conductive layer comprises first conductive patterns for forming a plurality of first coils; forming a second sheet, wherein the second sheet comprises a second insulating layer and at least one second conductive layer over the second insulating layer, wherein the at least one second conductive layer comprises second conductive patterns for forming a plurality of second coils; disposing the first sheet on a top surface of a third magnetic sheet; disposing the second sheet on a bottom surface of the third magnetic sheet; disposing a fourth magnetic sheet on a top surface of the first sheet; and disposing a fifth magnetic sheet on a bottom surface of the second sheet.

In one embodiment, the first insulating layer is in contact with the top surface of the third sheet, and the second insulating layer is in contact with the bottom surface of the third sheet.

In one embodiment, the method further comprising hot pressing said sheets to form a magnetic body; and cutting the magnetic body into a plurality of pieces with each piece comprising a corresponding portion of the magnetic body and two corresponding coils of a coupled inductor inside the corresponding portion of the magnetic body.

In one embodiment, a magnetic device is disclosed, wherein the magnetic device comprises: a body; a plurality of inductors, disposed in the body, wherein for each inductor, the inductor comprises at least one first conductive layer with each conductive layer being formed on a corresponding insulating layer, wherein the at least one first conductive layer comprises first conductive patterns for forming at least one first winding turn of a coil.

To make the aforementioned and other features and advantages of the present invention more comprehensible, several embodiments accompanied by figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention, the drawings are briefly described as follows.

FIGS. 1A-1D each shows a partial view of a conventional coupled inductor;

FIG. 2A shows a view of a coupled inductor according to one embodiment of the present invention;

FIG. 2B shows a coil structure formed on a carrier according to one embodiment of the present invention;

FIGS. 2C-2D each shows a corresponding coil structure after the carrier is removed according to one embodiment of the present invention;

FIG. 2E shows an exploded view of a coupled inductor according to one embodiment of the present invention;

FIGS. 3A-3B each illustrate a method to form a coupled inductor according to one embodiment of the present invention;

FIG. 4A shows stacked sheets for forming a plurality of coupled inductors according to one embodiment of the present invention;

FIG. 4B shows a way to align the sheets for forming a plurality of coupled inductors according to one embodiment of the present invention;

FIG. 5 illustrate a method to form a coupled inductor according to one embodiment of the present invention;

FIGS. 6A-6B each illustrates an array of inductors in a single package according to one embodiment of the present invention; and

FIGS. 7A-7B each illustrates an array of inductors in a single package according to one embodiment of the present invention.

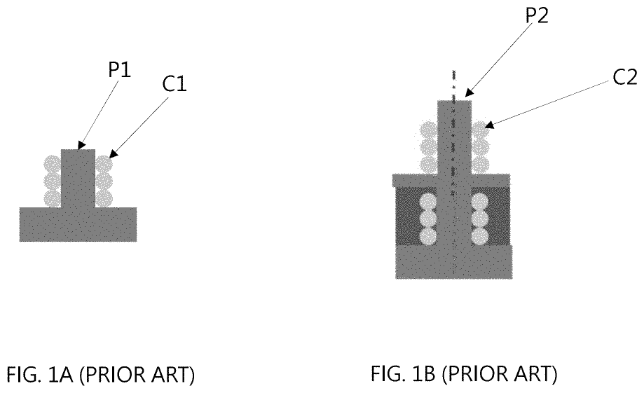

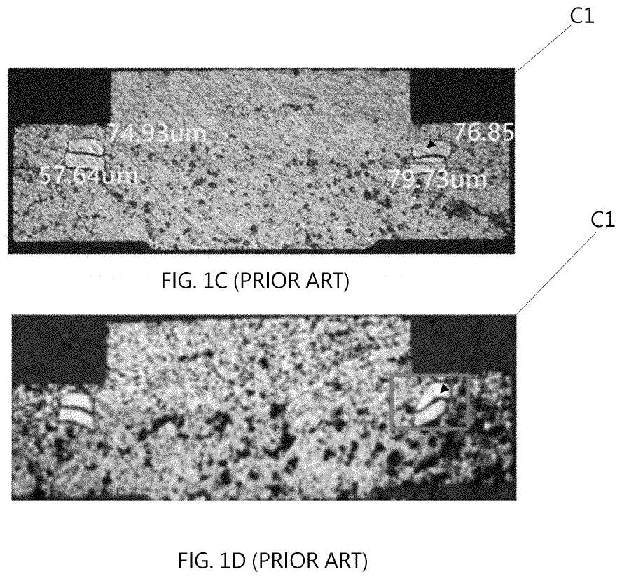

### DESCRIPTION OF EMBODIMENTS

The present invention discloses a coupled inductor, wherein the coupled inductor comprises: a first coil formed by a film process, wherein the first coil comprises at least one first winding turn; and a second coil formed by a film process, wherein the second coil comprises at least one second winding turn, wherein the gap between the bottom surface of the first coil and the top surface of the second coil can be minimized through the film process.

There are many ways to form the structure of the coupled inductor of the present invention, which will be described hereafter.

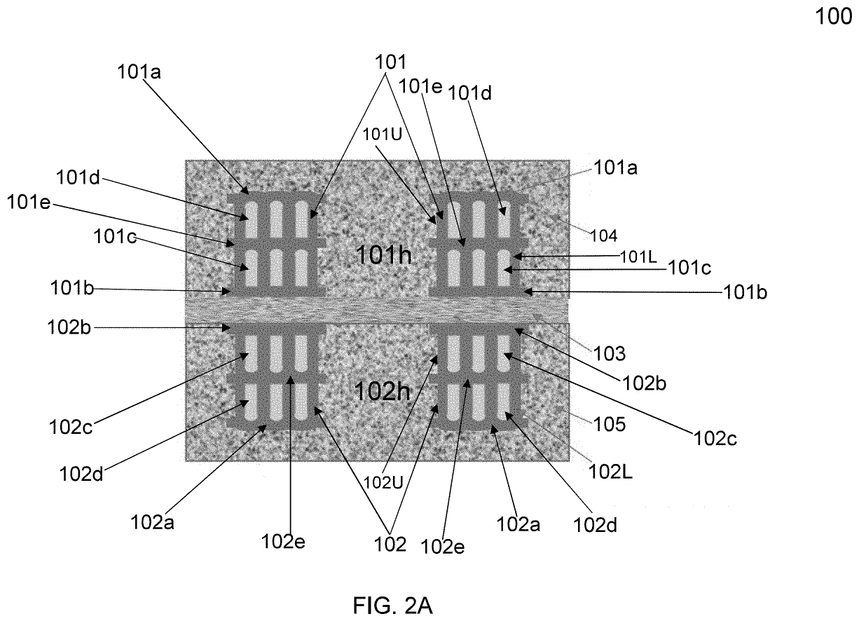

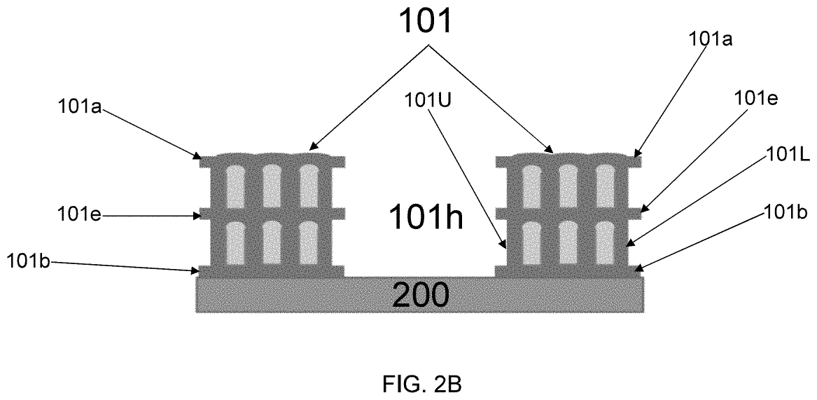

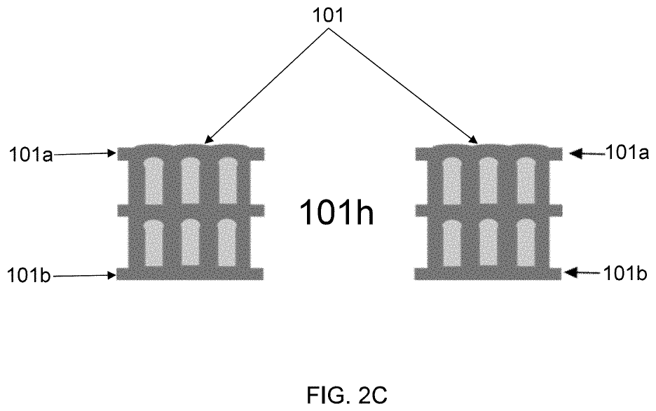

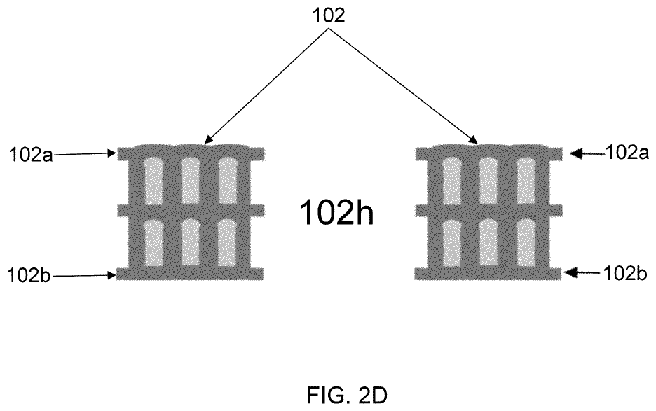

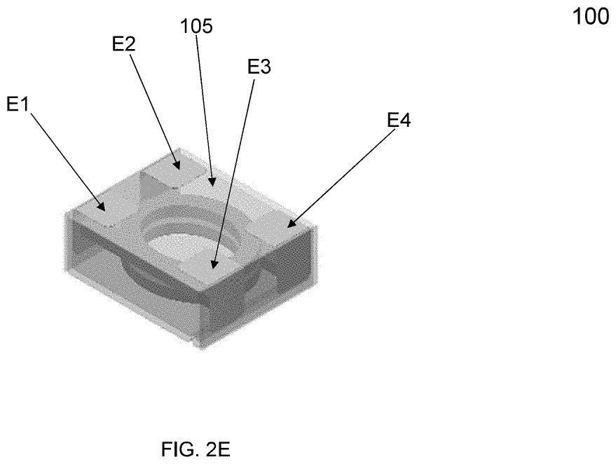

FIG. 2A shows a view of a coupled inductor according to one embodiment of the present invention. As shown in FIG. 2A, the coupled inductor 100 comprises: a first coil-structure 101, comprising at least one first conductive layer 101c, 101d, wherein each conductive layer 101c, 101d is formed on a corresponding insulating layer 101b, 101e, wherein the at least one first conductive layer 101c, 101d comprises first conductive patterns for forming at least one first winding turn of a first coil; a second coil-structure 102 comprising at least one second conductive layer 102c, 102d wherein each conductive layer 102c, 102d is formed on a corresponding insulating layer 102b, 102e, wherein the at least one second conductive layer 102c, 102d comprises second conductive patterns for forming at least one second winding turn of a second coil; a magnetic sheet 103, wherein the first coil-structure 101 is disposed over a top surface of the magnetic sheet 103, and the second coil-structure 102 is disposed over a bottom surface of the magnetic sheet 103, wherein the first coil-structure 101 and the second coil-structure 102 are on two opposite sides of the magnetic sheet 103, wherein a straight line passes through a first hollow space 101h of the at least one first winding turn of the first coil and a second hollow space 102h of the at least one second winding turn of the second coil.

In one embodiment, an outer side surface of each of the at least one first conductive layer 101c, 101d is encapsulated by an insulating layer 101L.

In one embodiment, an outer side surface of each of the at least one second conductive layer 102c, 102d is encapsulated by an insulating layer 102L.

In one embodiment, an inner side surface of each of the at least one first conductive layer 101c, 101d is encapsulated by an insulating layer 101U.

In one embodiment, an inner side surface of each of the at least one second conductive layer 102c, 102d is encapsulated by an insulating layer 102U.

In one embodiment, a first electrode E1 and a second electrode E2 of the coupled inductor are electrically connected to the first coil, and a third electrode E3 and a fourth electrode E4 of the coupled inductor are electrically connected to the second coil, as shown in FIG. 2E.

In one embodiment, wherein a vertical line passes through the first hollow space 101h of the at least one first winding turn of the first coil and the second hollow space 102h of the at least one second winding turn of the second coil.

In one embodiment, the coupled inductor 100 comprises: a first magnetic body 104, wherein the first magnetic body 104 is disposed on the top surface of the magnetic sheet 103 to encapsulate the at least one first winding turn of the first coil; and a second magnetic body 105, wherein the second magnetic body 105 is disposed on the bottom surface of the magnetic sheet 103 to encapsulate the at least one second winding turn of the second coil.

In one embodiment, a first electrode E1 and a second electrode E2 of the coupled inductor are electrically connected to the first coil, and a third electrode E3 and a fourth electrode E4 of the coupled inductor are electrically connected to the second coil, wherein the first electrode E1, the second electrode E2, the third electrode E3, and the fourth electrode E4 are disposed on a bottom surface of the second magnetic body 105, as shown in FIG. 2E.

In one embodiment, a first electrode and a second electrode of the coupled inductor are electrically connected to the first coil, and a third electrode and a fourth electrode of the coupled inductor are electrically connected to the second coil, wherein the first electrode, the second electrode, the third electrode, and the fourth electrode are disposed on a top surface of the first magnetic body 104.

In one embodiment, the at least one first conductive layer 101c, 101d comprises a first plurality of conductive layers 101c, 101d, wherein each conductive layer 101c, 101d of the first plurality of conductive layers is formed sequentially on a corresponding insulating layer 101b, 101d starting from a first bottom insulating layer 101b, wherein the first bottom insulating layer 101b is in contact with the top surface of the magnetic sheet. In one embodiment, the first bottom insulating layer 101b is formed on a carrier first, and the first plurality of conductive layers 101c, 101d are formed over the first bottom insulating layer 101b, and the carrier is removed after the first coil-structure 101 is formed.

In one embodiment, the at least one first conductive layer 101c, 101d comprises a first plurality of conductive layers 101c, 101d, wherein each conductive layer 101c, 101d of the first plurality of conductive layers is formed sequentially on a corresponding insulating layer 101b, 101d starting from a first bottom insulating layer 101b, wherein the first bottom insulating layer 101b is in contact with the top surface of the magnetic sheet 103.

In one embodiment, the first bottom insulating layer 101b is formed on a carrier first, and the first plurality of conductive layers 101c, 101d are formed over the first bottom insulating layer 101b, and the carrier is removed after the first coil-structure 101 is formed.

In one embodiment, the first plurality of conductive layers are located between the first bottom insulating layer 101b and a first top insulating layer 101a, wherein the first bottom insulating layer 101b is in contact with the top surface of the magnetic sheet 103.

In one embodiment, the at least one second conductive layer 201c, 201d comprises a second plurality of conductive layers 201c, 201d, wherein each conductive layer 201c, 201d of the second plurality of conductive layers is formed sequentially on a corresponding insulating layer 201b, 201d starting from a second bottom insulating layer 201b, wherein the second bottom insulating layer 201b is in contact with the top surface of the magnetic sheet 103.

In one embodiment, the second bottom insulating layer 201b is formed on a carrier first, and the second plurality of conductive layers 201c, 201d are formed over the second bottom insulating layer 201b, and the carrier is removed after the second coil-structure 102 is formed.

In one embodiment, the second plurality of conductive layers are located between the second bottom insulating layer and a second top insulating layer, wherein the second bottom insulating layer is in contact with the bottom surface of the magnetic sheet 103.

In one embodiment, the first magnetic body 104 comprises a first unitary magnetic body that encapsulates the at least one first winding turn of the first coil and extends into the first hollow space of the first coil.

In one embodiment, the second magnetic body 105 comprises a second unitary magnetic body that encapsulates the at least one second winding turn of the second coil and extends into the second hollow space of the first coil.

In one embodiment, the first winding turn is formed on the first bottom insulating layer, wherein a corresponding insulating layer is formed on a first conductive layer comprising the first winding turn, wherein said corresponding insulating layer encapsulates the first winding turn and extends into an unpatterned area of the first conductive layer.

In one embodiment, the second winding turn is formed on the second bottom insulating layer, wherein a corresponding insulating layer is formed on a second conductive layer comprising the second winding turn, wherein said corresponding insulating layer encapsulates the second winding turn and extends into an unpatterned area of the second conductive layer.

In one embodiment, the first coil is formed by a first plurality of conductive layers by a film process, wherein the first winding turn of the first coil is formed on the first insulating layer, wherein a third insulating layer is formed on the first winding turn, and a third winding turn is formed on the third insulating layer, wherein a fifth insulating layer is formed on a top surface of the first coil, wherein the first insulating layer is in contact with the top surface of the magnetic sheet.

In one embodiment, the first insulating layer can be formed on a first carrier 200, as shown in FIG. 2B, and the first carrier 200 is removed after the first coil-structure 101 is formed, as shown in FIG. 2C, wherein a hollow space 101h of the first coil is formed.

In one embodiment, the second coil is formed by a second plurality of conductive layers by a film process, wherein the second winding turn is formed on the second insulating layer, wherein a fourth insulating layer is formed on the second winding turn, and a fourth winding turn is formed on the fourth insulating layer, wherein a sixth insulating layer is formed on a top surface of the second coil, wherein the second insulating layer is in contact with the bottom surface of the magnetic sheet.

In one embodiment, the second insulating layer can be formed on a second carrier; and the second carrier is removed after the second coil-structure 102 is formed, as shown in FIG. 2D, wherein a hollow space 102h of the second coil is formed.

In one embodiment, each of the at least one first conductive layer is formed by a thin film process.

In one embodiment, each of the first conductive layer is formed by a thick film process.

In one embodiment, the first magnetic body is formed by a first material, and the magnetic sheet is formed by a second material that is different from the first material.

In one embodiment, each of the first magnetic body and the magnetic sheet is formed by a first material.

In one embodiment, each of the first magnetic body and the second magnetic body is formed by a first material, and the magnetic sheet is formed by a second material that is different from the first material.

In one embodiment, the first magnetic body is formed by a first material, the magnetic sheet is formed by a second material, and the second magnetic body is formed by a third material, wherein the first material, the second material, and the third material are different from each other.

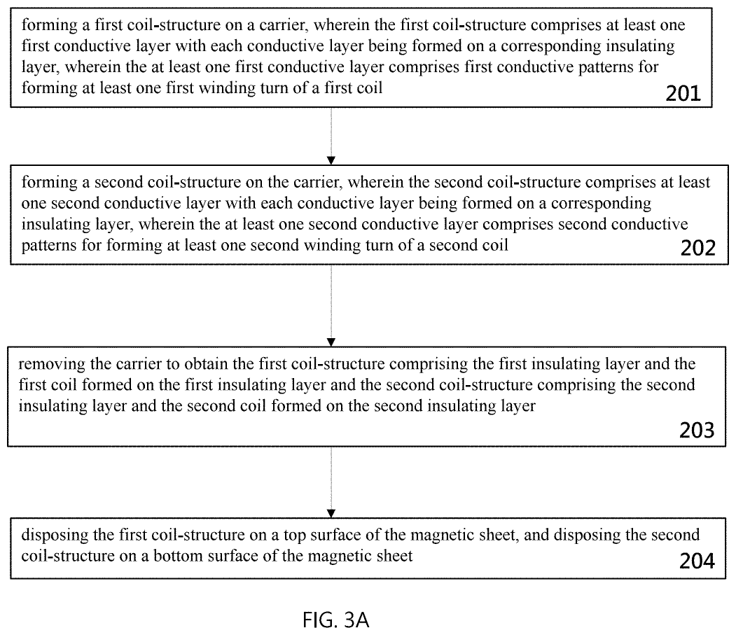

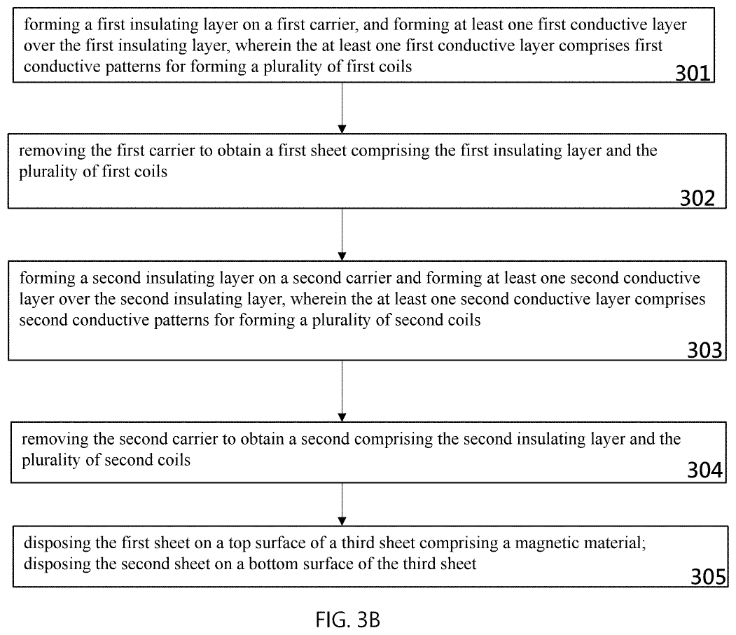

In one embodiment, as shown in FIG. 3A, a method to form a coupled inductor is disclosed, wherein said method comprises: step 201: forming a first coil-structure on a carrier, wherein the first coil-structure comprises at least one first conductive layer with each conductive layer being formed on a corresponding insulating layer, wherein the at least one first conductive layer comprises first conductive patterns for forming at least one first winding turn of a first coil; step 202: forming a second coil-structure on the carrier, wherein the second coil-structure comprises at least one second conductive layer with each conductive layer being formed on a corresponding insulating layer, wherein the at least one second conductive layer comprises second conductive patterns for forming at least one second winding turn of a second coil; step 203: removing the carrier to obtain the first coil-structure comprising the first insulating layer and the first coil formed on the first insulating layer and the second coil-structure comprising the second insulating layer and the second coil formed on the second insulating layer; step 204: disposing the first coil-structure on a top surface of the magnetic sheet, and disposing the second coil-structure on a bottom surface of the magnetic sheet.

In one embodiment, a vertical line passes through a first hollow space of the at least one first winding turn of the first coil and a second hollow space of the at least one second winding turn of the second coil.

In one embodiment, each of the at least one first conductive layer is formed by a film process.

In one embodiment, each of the at least one first conductive layer is a metal layer formed by a thin film process.

In one embodiment, the first conductive layer is formed by a thick film process.

In one embodiment, the method further comprises disposing a first magnetic body on the top surface of the magnetic sheet to encapsulate the at least one first winding turn of the first coil and extend into the first hollow space of the first coil.

In one embodiment, the method further comprises disposing a second magnetic body on the bottom surface of the magnetic sheet to encapsulate the at least one second winding turn of the second coil and extend into the first second space of the second coil.

In one embodiment, the first magnetic body is formed by a first material, and the magnetic sheet is formed by a second material that is different from the first material.

In one embodiment, each of the first magnetic body and the magnetic sheet is formed by a first material.

In one embodiment, each of the first magnetic body and the second magnetic body is formed by a first material, and the magnetic sheet is formed by a second material that is different from the first material.

In one embodiment, the first magnetic body is formed by a first material, the magnetic sheet is formed by a second material, and the second magnetic body is formed by a third material, wherein the first material, the second material, and the third material are different from each other.

In one embodiment, the first insulating layer is in contact with the top surface of the magnetic sheet, and the second insulating layer is in contact with the bottom surface of the magnetic sheet.

In one embodiment, the first coil is formed by a first plurality of conductive layers, wherein the first winding turn is formed on a first insulating layer disposed on the carrier, wherein a third insulating layer is formed on the first winding turn, wherein the first insulating layer is in contact with the top surface of the magnetic sheet.

In one embodiment, the second coil is formed by a second plurality of conductive layers, wherein the second winding turn is formed on a second insulating layer disposed on the carrier, wherein a fourth insulating layer is formed on the first winding turn, wherein the second insulating layer is in contact with the bottom surface of the magnetic sheet.

In one embodiment, the first coil is formed by a first plurality of conductive layers, wherein the first winding turn is formed on the first insulating layer, wherein a third insulating layer is formed on the first winding turn, and a third winding turn is formed on the third insulating layer, wherein a fifth insulating layer is formed on a top surface of the first coil, wherein the first insulating layer is in contact with the top surface of the magnetic sheet.

In one embodiment, as shown in FIG. 3B, a method for forming a plurality of coupled inductors is disclosed, wherein the method comprises: step 301: forming a first insulating layer on a first carrier, and forming at least one first conductive layer over the first insulating layer, wherein the at least one first conductive layer comprises first conductive patterns for forming a plurality of first coils; 302: removing the first carrier to obtain a first sheet comprising the first insulating layer and the plurality of first coils; step 303: forming a second insulating layer on a second carrier and forming at least one second conductive layer over the second insulating layer, wherein the at least one second conductive layer comprises second conductive patterns for forming a plurality of second coils; step 304: removing the second carrier to obtain a second comprising the second insulating layer and the plurality of second coils; step 305: disposing the first sheet on a top surface of a third sheet comprising a magnetic material and disposing the second sheet on a bottom surface of the third sheet.

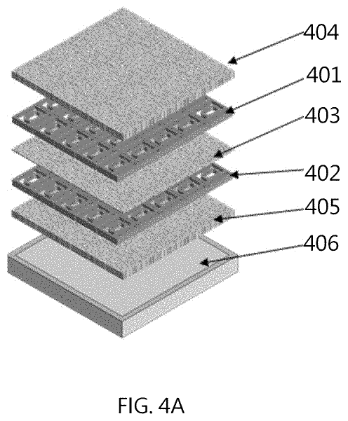

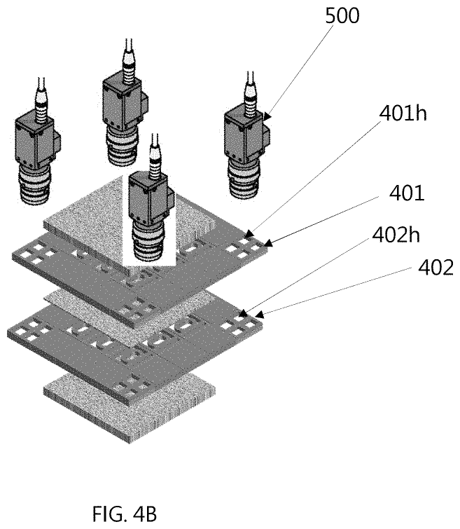

As shown in FIG. 4A, the first sheet 401 is disposed on the top surface of the third sheet 403, and the second sheet 402 is disposed on a bottom surface of the third sheet.

In one embodiment, the method comprises disposing a fourth sheet 404 comprising a magnetic material on the top surface of the first sheet 401. As shown in FIG. 4A, the fourth sheet 404 is disposed on the top surface of the first sheet 401.

In one embodiment, the method comprises disposing a fifth sheet 405 comprising a magnetic material on the bottom surface of the second sheet 402. As shown in FIG. 4A, the fifth sheet 405 is disposed on the bottom surface of the second sheet 402.

In one embodiment, as shown in FIG. 4A, the sheets 401, 402, 403, 404, 405 can be disposed in a mode 406 for alignment of the sheets 401, 402 comprising coils. The alignment of the coils can be side alignment, pin alignment, or tendon alignment. Different from the prior art, batch alignment accuracy is a fixed value, which can reduce the gap variations for all finished products in batch production.

In one embodiment, the sheets 401, 402 comprising coils can be aligned by the optical alignment such as CCD, laser, image, etc. As shown in FIG. 4B, each of the sheets 401, 402 has some holes 401h, 402h for passing the lights from CCD 500 for alignment of the sheets 401, 402 comprising coils. Different from the prior art, batch alignment accuracy is a fixed value, which can reduce the gap variations for all finished products.

In one embodiment, the first insulating layer is in contact with the top surface of the third sheet, and the second insulating layer is in contact with the bottom surface of the third sheet.

In one embodiment, the first coil is formed by a first plurality of conductive layers, wherein the first winding turn is formed on a first insulating layer disposed on the carrier, wherein a third insulating layer is formed on the first winding turn, wherein the first insulating layer is in contact with the top surface of the magnetic sheet.

In one embodiment, the second coil is formed by a second plurality of conductive layers, wherein the second winding turn is formed on a second insulating layer disposed on the carrier, wherein a fourth insulating layer is formed on the first winding turn, wherein the second insulating layer is in contact with the bottom surface of the magnetic sheet.

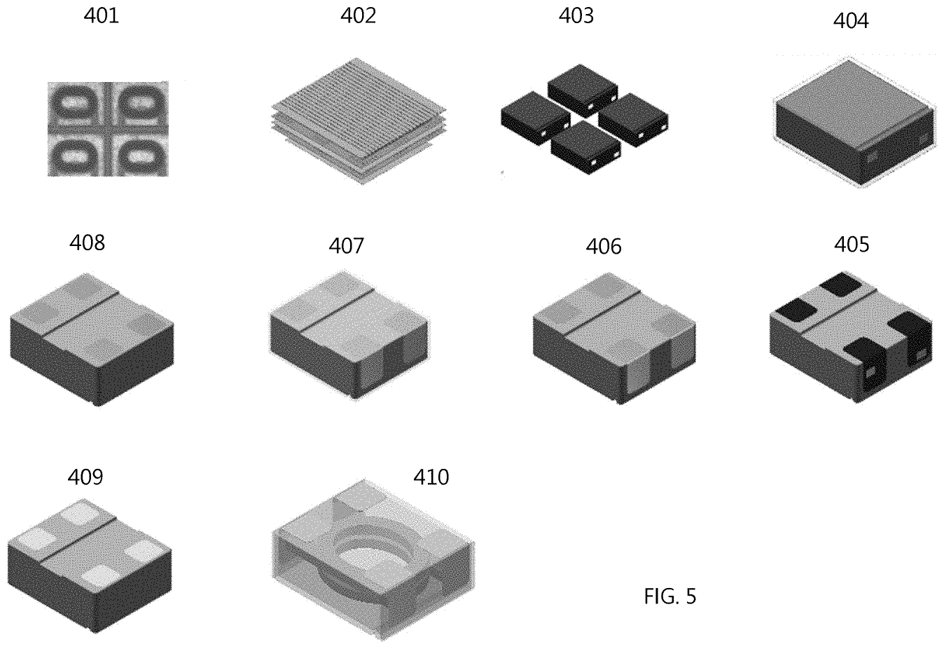

In one embodiment, as shown in FIG. 5, a method for forming a plurality of coupled inductors is disclosed, wherein the method comprises: step 401: forming a first sheet and a second sheet by film processes, wherein each of the first sheet and the second sheet comprises at least one conductive layer with each conductive layer formed on a corresponding insulating layer, wherein the at least one conductive layer comprises conductive patterns for forming a plurality of coils; 402: disposing the first sheet on a top surface of a third sheet comprising a magnetic material and disposing the second sheet on a bottom surface of the third sheet, wherein a fourth sheet is disposed on the top surface of the first sheet 401 and a fifth sheet 405 is disposed on the bottom surface of the second sheet 402, wherein the stacked sheets are hot pressed to form a magnetic body with coils of coupled inductors inside the magnetic body; step 403: cutting the magnetic body into a plurality of pieces with each piece comprising a corresponding portion of the magnetic body and two corresponding coils of a coupled inductor inside the corresponding portion of the magnetic body; step 404: spraying paint on the magnetic body of the coupled inductor; step 405: peeling paint from the magnetic body of the coupled inductor; step 406: electroplating Cu paint on the magnetic body; step 407: spraying paint; step 408: peeling paint; step 409: electroplating Cu/Ni/Sn; step 410: finished product of the coupled inductor.

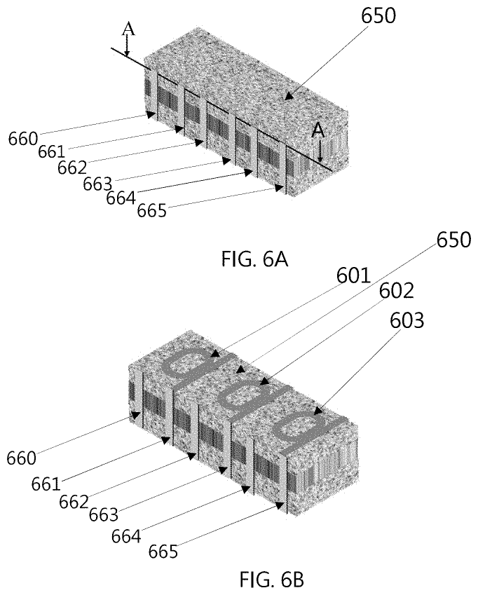

In one embodiment, multiple inductors can be disposed in a single package as an array of inductors, as shown in FIG. 6A, three inductors can be in parallel, and six electrodes 660 are disposed on the body 650 of the array of coupled inductors, such as the six electrodes 660 on a lateral surface crossing the AA line, as shown in FIG. 6B, wherein each inductor comprises a corresponding coil 601, 602, 603, wherein each coil comprises at least one first conductive layer 101c, 101d wherein each conductive layer 101c, 101d is formed on a corresponding insulating layer 101b, 101e wherein the at least one first conductive layer 101c, 101d comprises first conductive patterns for forming at least one first winding turn of a coil, as shown in FIG. 2A. In one embodiment, the body 650 is a magnetic body. In one embodiment, the array of coupled inductors are placed along a horizontal direction. In one embodiment, the body 750 is a unitary magnetic body, wherein the unitary magnetic body encapsulates the array of inductors and extends into hollow space of each inductor.

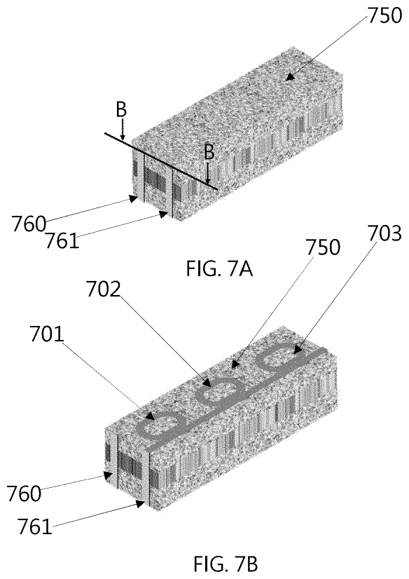

In one embodiment, multiple inductors can be disposed in a single package as an array of inductors, as shown in FIG. 7A, three inductors can be connected in series, and two electrodes are disposed on the body 750 of the array of coupled inductors, such as the two electrodes 760 on a lateral surface crossing the BB line, as shown in FIG. 7B, wherein each inductor comprises a corresponding coil 701, 702, 703 that are connected in series, wherein each coil at least one first conductive layer 101c, 101d wherein each conductive layer 101c, 101d is formed on a corresponding insulating layer 101b, 101e wherein the at least one first conductive layer 101c, 101d comprises first conductive patterns for forming at least one first winding turn of a coil, as shown in FIG. 2A. In one embodiment, the body 750 is a magnetic body. In one embodiment, the array of coupled inductors are placed along a horizontal direction. In one embodiment, the body 750 is a unitary magnetic body, wherein the unitary magnetic body encapsulates the array of inductors and extends into hollow space of each inductor.

The present invention can achieve the following advantages: the standard deviation of the gap between the upper coil and the lower coil in finished coupled inductors can be reduced from 2.6 to 0.6 through structural design optimization, especially using the flatness of the bottom insulating layer of the upper coil structure and the flatness of the bottom insulating layer of the lower coil structure to form the gap between the upper coil and lower coil of the coupled inductor, which can improve product reliability and performance. In addition, the present invention can improve product quality and yield of the coupled inductors, wherein the standard deviation of K (coupling coefficient) value is decreased significantly to 0.017, by using the flatness of the bottom insulating layer of the upper coil structure and the flatness of the bottom insulating layer of the lower coil structure.

Although the present invention has been described with reference to the above embodiments, it will be apparent to one of ordinary skill in the art that modifications to the described embodiment may be made without departing from the spirit of the invention. Accordingly, the scope of the invention will be defined by the attached claims not by the above-detailed descriptions.

What is claimed is:

1. A coupled inductor, comprising:
a first coil-structure, comprising at least one first conductive layer, wherein each conductive layer is formed on a corresponding insulating layer, wherein the at least one first conductive layer comprises first conductive patterns for forming at least one first winding turn of a first coil;
a second coil-structure, comprising at least one second conductive layer, wherein each conductive layer is formed on a corresponding insulating layer, wherein the at least one second conductive layer comprises second conductive patterns for forming at least one second winding turn of a second coil; and
a magnetic sheet, wherein the first coil-structure is disposed over a top surface of the magnetic sheet, and the second coil-structure is disposed over a bottom surface of the magnetic sheet, wherein the first coil-structure and the second coil-structure are on two opposite sides of the magnetic sheet.

2. The coupled inductor according to claim 1, further comprising a first magnetic body and a second magnetic body, wherein the first magnetic body is disposed on the top surface of the magnetic sheet to encapsulate the at least one first winding turn of the first coil, and wherein the second magnetic body is disposed on the bottom surface of the magnetic sheet to encapsulate the at least one second winding turn of the second coil.

3. The coupled inductor according to claim 2, wherein the at least one first conductive layer comprises a first plurality of conductive layers, wherein each conductive layer of the first plurality of conductive layers is formed sequentially on a corresponding insulating layer starting from a first bottom insulating layer, wherein the first bottom insulating layer is in contact with the top surface of the magnetic sheet.

4. The coupled inductor according to claim 2, wherein the at least one first conductive layer comprises a first plurality of conductive layers, wherein each conductive layer of the first plurality of conductive layers is formed sequentially on a corresponding insulating layer starting from a first bottom insulating layer, wherein the first plurality of conductive layers are located between the first bottom insulating layer and a first top insulating layer, wherein the first bottom insulating layer is in contact with the top surface of the magnetic sheet.

5. The coupled inductor according to claim 2, wherein the at least one second conductive layer comprises a second plurality of conductive layers, wherein each conductive layer of the second plurality of conductive layers is formed sequentially on a corresponding insulating layer starting from a second bottom insulating layer, wherein the second bottom insulating layer is in contact with the bottom surface of the magnetic sheet.

6. The coupled inductor according to claim 2, wherein the at least one second conductive layer comprises a second plurality of conductive layers, wherein each conductive layer of the second plurality of conductive layers is formed sequentially on a corresponding insulating layer starting from a second bottom insulating layer, wherein the second plurality of conductive layers are located between the second bottom insulating layer and a second top insulating layer, wherein the second bottom insulating layer is in contact with the bottom surface of the magnetic sheet.

7. The coupled inductor according to claim 2, wherein the first magnetic body comprises a first unitary magnetic body that encapsulates the at least one first winding turn of the first coil and extends into a first hollow space of the first coil.

8. The coupled inductor according to claim 2, wherein the second magnetic body comprises a second unitary magnetic body that encapsulates the at least one second winding turn of the second coil and extends into a second hollow space of the first coil.

9. The coupled inductor according to claim 2, wherein the first winding turn is formed on the first bottom insulating layer, wherein a corresponding insulating layer is formed on a first conductive layer comprising the first winding turn, wherein said corresponding insulating layer encapsulates the first winding turn and extends into an unpatterned area of the first conductive layer.

10. The coupled inductor according to claim 2, wherein the second winding turn is formed on the second bottom insulating layer, wherein a corresponding insulating layer is formed on a second conductive layer comprising the second winding turn, wherein said corresponding insulating layer encapsulates the second winding turn and extends into an unpatterned area of the second conductive layer.

11. The coupled inductor according to claim 1, wherein each of the at least one first conductive layer is formed by a film process.

12. The coupled inductor according to claim 1, wherein each of the at least one first conductive layer is formed by a thin film process.

13. The coupled inductor according to claim 2, wherein the first magnetic body is formed by a first material, and the magnetic sheet is formed by a second material that is different from the first material.

14. The coupled inductor according to claim 2, where each of the first magnetic body and the second magnetic body is formed by a first material, and the magnetic sheet is formed by a second material that is different from the first material.

15. A method for forming a plurality of coupled inductors, said method comprising:
forming a first sheet, wherein the first sheet comprises a first insulating layer and at least one first conductive layer over the first insulating layer, wherein the at least one first conductive layer comprises first conductive patterns for forming a plurality of first coils;
forming a second sheet, wherein the second sheet comprises a second insulating layer and at least one second conductive layer over the second insulating layer, wherein the at least one second conductive layer comprises second conductive patterns for forming a plurality of second coils;
disposing the first sheet on a top surface of a third magnetic sheet;
disposing the second sheet on a bottom surface of the third magnetic sheet;
disposing a fourth magnetic sheet on a top surface of the first sheet;
disposing a fifth magnetic sheet on a bottom surface of the second sheet.

16. The method according to claim 15, wherein the first insulating layer is in contact with the top surface of the third sheet, and the second insulating layer is in contact with the bottom surface of the third sheet.

17. The method according to claim 15, further comprising hot pressing said sheets to form a magnetic body; and cutting the magnetic body into a plurality of pieces with each piece comprising a corresponding portion of the magnetic body and two corresponding coils of a coupled inductor inside the corresponding portion of the magnetic body.

18. A magnetic device, comprising:
a body;
a plurality of inductors, disposed in the body, wherein for each inductor, the inductor comprises at least one first conductive layer with each conductive layer being formed on a corresponding insulating layer, wherein the at least one first conductive layer comprises first conductive patterns for forming at least one first winding turn of a coil.

19. The magnetic device according to claim 18, wherein the plurality of inductors are connected in series in the magnetic device, wherein two electrodes are disposed on the body.

20. The magnetic device according to claim 18, wherein each inductor has two separated electrodes disposed on the body, respectively.
